(19) United States
(12) Patent Application Publication
(10) Pub. No.: US 2025/0102979 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Yasushi NAGATA, Kanagawa (JP); Toshiyuki Miyata, Kanagawa (JP); Keitaro Mori, Kanagawa (JP); Motoharu Nakao, Kanagawa (JP)

(73) Assignee: FUJIFILM Business Innovation Corp., Tokyo (JP)

(21) Appl. No.: 18/438,030

(22) Filed: Feb. 9, 2024

(30) Foreign Application Priority Data
Sep. 27, 2023 (JP) 2023-166479

(51) Int. Cl. G03G 15/20; G03G 15/00; G03G 15/01

(52) U.S. Cl. CPC G03G 15/2064; G03G 15/0189; G03G 15/2039; G03G 15/6576

(57) ABSTRACT

A fixing device includes: a fixing unit that fixes an image on a surface of a medium by pressing the image while heating the image, the fixing unit including a base layer and a surface layer that is composed of a tube having a crease and covering the base layer and of which a coefficient of thermal expansion is different from a coefficient of thermal expansion of the base layer; and a controlling unit that controls the fixing unit, the controlling unit executing a crease removal operation of smoothing out the crease before a start of a fixing operation in a case where the fixing operation is started and a predetermined condition under which the crease deteriorates is satisfied.

### CROSS-REFERENCE TO RELATED APPLICATIONS

This application is based on and claims priority under 35 USC 119 from Japanese Patent Application No. 2023-166479 filed Sep. 27, 2023.

### BACKGROUND

### (i) Technical Field

The present invention relates to a fixing device and an image forming apparatus including the fixing device.

### (ii) Related Art

Regarding a fixing device that fixes an image in an image recording device, a technique described in JP2001-109295A ([0023] to [0035] and FIG. 3) is already known.

Described in JP2001-109295A ([0023] to [0035] and FIG. 3) is a configuration in which a fixing member or a pressing member are covered with a fluororesin tube. Regarding the fluororesin tube of JP2001-109295A ([0023] to [0035] and FIG. 3), a recess and a protrusion at a crease are formed due to a step at the time of manufacture and the recess and the protrusion at the crease are flattened through a flattening process.

### SUMMARY

Aspects of non-limiting embodiments of the present disclosure relate to a fixing device and an image forming apparatus that suppress a decrease in image quality caused by a crease in comparison with the related art in which a crease deteriorating after operation of the image forming apparatus is not coped with, the fixing device using a fluororesin tube having a crease as a surface layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: a fixing unit that fixes an image on a surface of a medium by pressing the image while heating the image, the fixing unit including a base layer and a surface layer that is composed of a tube having a crease and covering the base layer and of which a coefficient of thermal expansion is different from a coefficient of thermal expansion of the base layer; and a controlling unit that controls the fixing unit, the controlling unit executing a crease removal operation of smoothing out the crease before a start of a fixing operation in a case where the fixing operation is started and a predetermined condition under which the crease deteriorates is satisfied.

### BRIEF DESCRIPTION OF THE DRAWINGS

Exemplary embodiment(s) of the present invention will be described in detail based on the following figures, wherein:

FIG. 1 is an overall explanatory view of an image forming apparatus of Example 1;

FIG. 2 is an explanatory view of a major portion of an image recording section of Example 1;

FIG. 3 is a cross-sectional view of a fixing unit of a fixing device of Example 1;

FIG. 4 is a functional block diagram of a control section of Example 1; and

FIG. 5 is a flowchart of a control process for the fixing device of Example 1.

### DETAILED DESCRIPTION

Next, an example as a specific example of an exemplary embodiment of the present invention will be described with reference to the drawings. However, the present invention is not limited to an example as follows.

For the sake of easy understanding of the following description, in the drawings, a front-rear direction will be referred to as an X-axis direction, a right-left direction will be referred to as a Y-axis direction, and a vertical direction will be referred to as a Z-axis direction. Directions and sides represented by arrows X, -X, Y, -Y, Z, and -Z are a frontward direction, a rearward direction, a rightward direction, a leftward direction, an upward direction, a downward direction, a front side, a rear side, a right side, a left side, an upper side, and a lower side, respectively.

In addition, in the drawings, a circle with a point therein means an arrow from the back of the paper to the front of the paper and a circle with a cross therein means an arrow from the front of the paper to the back of the paper.

In the following description which will be made by using the drawings, members other than members necessary for the description are not shown as appropriate for the sake of easy understanding.

### EXAMPLE 1

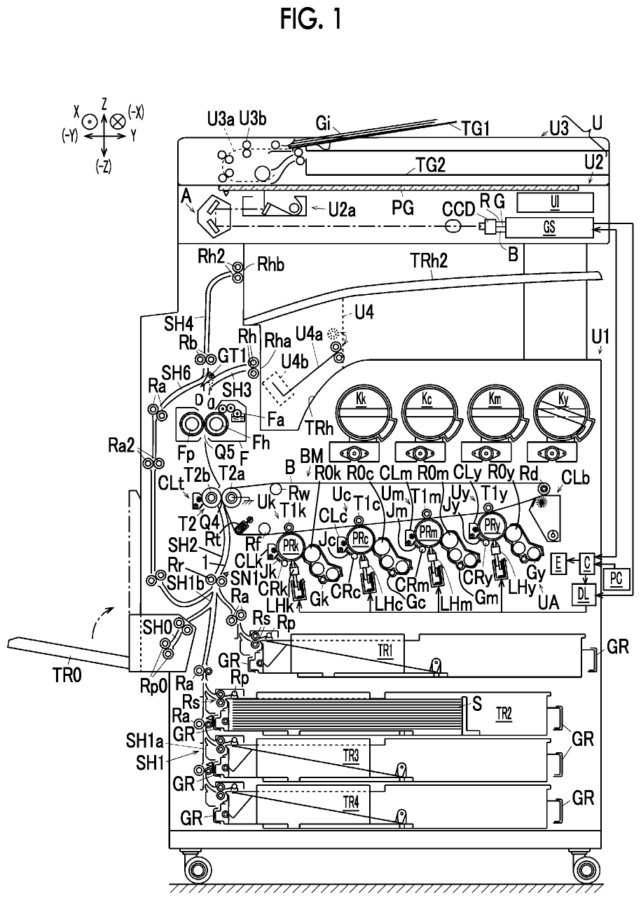

FIG. 1 is an overall explanatory view of an image forming apparatus of Example 1.

In FIG. 1, a copier U which is an example of the image forming apparatus of Example 1 of the present invention has a printer section U1, which is an example of image recording means and is an example of an image recording device. A scanner section U2, which is an example of reading means and is an example of an image reading device, is supported above the printer section U1. An autofeeder U3 which is an example of a document transporting device is supported above the scanner section U2.

A document tray TG1 which is an example of medium accommodating means is disposed above the autofeeder U3. A plurality of documents Gi to be copied can be stacked and accommodated in the document tray TG1. Below the document tray TG1, a document discharge tray TG2 which is an example of a document discharge portion is formed. Between the document tray TG1 and the document discharge tray TG2, document transport rollers U3b are disposed along a document transport path U3a.

Platen glass PG which is an example of a transparent document table is disposed on an upper surface of the scanner section U2. In the scanner section U2 of Example 1, a reading unit U2a which is an example of a reading section is disposed below the platen glass PG. The reading unit U2a of Example 1 is supported to be movable in a right-left direction, which is an example of a sub-scanning direction, along a lower surface of the platen glass PG. The reading unit U2a is electrically connected to an image processing unit GS.

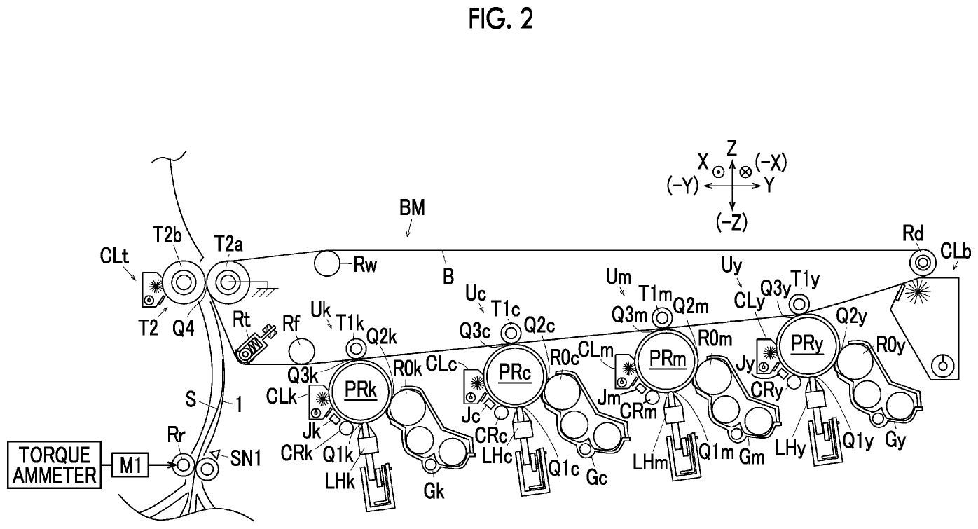

FIG. 2 is an explanatory view of a major portion of an image recording section of Example 1.

The image processing unit GS is electrically connected to a writing circuit DL of the printer section U1. The writing circuit DL is electrically connected to exposure devices LHy, LHm, LHc, and LHk each of which is an example of latent image forming means.

For example, each of the exposure devices LHy to LHk of Example 1 is composed of an LED head in which a plurality of LEDs are arranged in a main scanning direction. The exposure devices LHy to LHk are configured to output writing light beams corresponding to respective colors of Y, M, C, and K according to a signal input from the writing circuit DL.

In the writing circuit DL and a power supply circuit E, a writing timing and a power supply timing are controlled in accordance with a control signal from a control section C which is an example of control means.

In FIG. 1, photoreceptors PRy, PRm, PRc, and PRk each of which is an example of an image holding unit are disposed above the exposure devices LHy to LHk. In FIGS. 1 and 2, writing regions Q1y, Q1m, Q1c, and Q1k are composed of regions in which the photoreceptors PRy to PRk are irradiated with the writing light beams.

Charging rollers CRy, CRm, CRc, and CRk each of which is an example of charging means are disposed upstream of the writing regions Q1y to Q1k in respective rotation directions of the photoreceptors PRy to PRk. The charging rollers CRy to CRk of Example 1 come into contact with the photoreceptors PRy to PRk and are supported to be rotatable by being driven by the photoreceptors PRy to PRk.

Developing devices Gy, Gm, Gc, and Gk each of which is an example of developing means are disposed downstream of the writing regions Q1y to Q1k in the rotation directions of the photoreceptors PRy to PRk. Development regions Q2y, Q2m, Q2c, and Q2k are composed of regions in which the photoreceptors PRy to PRk and the developing devices Gy to Gk respectively face each other.

Primary transfer rollers T1y, T1m, T1c, and T1k each of which is an example of primary transfer means are disposed downstream of the developing devices Gy to Gk in the rotation directions of the photoreceptors PRy to PRk. Primary transfer regions Q3y, Q3m, Q3c, and Q3k are composed of regions in which the photoreceptors PRy to PRk and the primary transfer rollers T1y to T1k respectively face each other.

Photoreceptor cleaners CLy, CLm, CLc, and CLk each of which is an example of cleaning means are disposed downstream of the primary transfer rollers T1y to T1k in the rotation directions of the photoreceptors PRy to PRk.

Static eliminators Jy, Jm, Jc, and Jk, each of which is an example of static elimination means and each of which is an example of a static elimination device, are disposed downstream of the photoreceptor cleaners CLy to CLk in the rotation directions of the photoreceptors PRy to PRk.

The Y-color photoreceptor PRy, the charging roller CRy, the exposure device LHy, the developing device Gy, the primary transfer roller T1y, the photoreceptor cleaner CLy, and the static eliminator Jy constitute a Y-color image forming unit Uy, which is an example of Y-color visible image forming means of Example 1 that forms a Y-color toner image. Similarly, the photoreceptors PRm, PRc, and PRk, the charging rollers CRm, CRc, and CRk, the exposure devices LHm, LHc, and LHk, the developing devices Gm, Gc, and Gk, the primary transfer rollers T1m, T1c, and T1k, the photoreceptor cleaners CLm, CLc, and CLk, and the static eliminators Jm, Jc, and Jk constitute M-color, C-color, and K-color image forming units Um, Uc, and Uk.

A belt module BM which is an example of an intermediate transfer device is disposed above the photoreceptors PRy to PRk. The belt module BM has an intermediate transfer belt B, which is an example of an image holding unit and is an example of intermediate transfer means. The intermediate transfer belt B is composed of an endless band-shaped member.

The intermediate transfer belt B of Example 1 is supported to be rotatable by a tension roller Rt which is an example of tensioning means, a walking roller Rw which is an example of deviation correction means, an idler roller Rf which is an example of driven means, a back-up roller T2a which is an example of means facing a secondary transfer region, the primary transfer rollers T1y to T1k, and a drive roller Rd each of which is an example of a drive member. In Example 1, the intermediate transfer belt B rotates in a case where a drive force is transmitted to the drive roller Rd.

A secondary transfer roller T2b which is an example of secondary transfer means is disposed at a position facing the back-up roller T2a with the intermediate transfer belt B interposed therebetween. The back-up roller T2a, the secondary transfer roller T2b, and the like constitute a secondary transfer device T2 of Example 1 which is an example of a transfer device. In addition, a secondary transfer region Q4 is composed of a region in which the secondary transfer roller T2b comes into contact with the intermediate transfer belt B.

A belt cleaner CLb which is an example of a cleaning device for an intermediate transfer body is disposed downstream of the secondary transfer region Q4 in a rotation direction of the intermediate transfer belt B.

A transfer device T1+T2+B of Example 1 which is an example of a transfer unit is composed of the primary transfer rollers T1y to T1k, the intermediate transfer belt B, the secondary transfer device T2, and the like. In addition, an image recording section Uy to Uk +T1+T2+B of Example 1 is composed of the image forming units Uy to Uk and the transfer device T1+T2+B.

In FIG. 1, pairs of right and left guide rails GR each of which is an example of a guide unit are provided in four stages below the image forming units Uy to Uk. The guide rails GR respectively support paper feed trays TR1, TR2, TR3, and TR4 each of which is an example of medium accommodating means such that the paper feed trays TR1, TR2, TR3, and TR4 can enter and exit in the front-rear direction. Recording sheets S each of which is an example of a medium are accommodated in the paper feed trays TR1 to TR4.

A pick-up roller Rp which is an example of taking-out means is disposed on an upper left side of each of the paper feed trays TR1 to TR4. A separating roller Rs which is an example of separating means is disposed downstream of the pick-up roller Rp in a transport direction of the recording sheet S. A paper feed path SH1 extending upward which is an example of a medium transport path is formed downstream of the separating roller Rs in the transport direction of the recording sheet S. A plurality of transport rollers Ra each of which is an example of transporting means are disposed on the paper feed path SH1.

A manual tray TR0 which is an example of medium accommodating means is disposed at a lower left portion of the copier U. A pick-up roller Rp0 is disposed at an upper right portion of the manual tray TR0, and a manual paper feed path SH0 extends at the upper right portion. The manual paper feed path SH0 joins the paper feed path SH1.

On the paper feed path SH1, a registration roller Rr which is an example of transport timing adjusting means is disposed upstream of the secondary transfer region Q4. A transport path SH2 extends from the registration roller Rr toward the secondary transfer region Q4.

A fixing device F is disposed downstream of the secondary transfer region Q4 in the transport direction of the recording sheet S. The fixing device F has a heating roller Fh which is an example of a fixing unit for heating and a pressing roller Fp which is an example of a fixing unit for pressing. A fixing region Q5 is composed of a contact region between the heating roller Fh and the pressing roller Fp.

A lower paper discharge tray TRh which is an example of a medium discharge portion is formed on an upper surface of the printer section U1. Note that in Example 1, a finisher U4 which is an example of a post-processing device is installed at the lower paper discharge tray TRh. Above the fixing device F, a paper discharge path SH3 which is an example of a transport path extends toward the lower paper discharge tray TRh. A paper discharge roller Rh which is an example of medium transporting means is disposed at a downstream end of the paper discharge path SH3.

An upper paper discharge tray TRh2 which is an example of the medium discharge portion is disposed above the lower paper discharge tray TRh. An upper transport path SH4 that branches off from the paper discharge path SH3 and extends toward the upper paper discharge tray TRh2 is formed above the fixing device F.

On the upper transport path SH4, a reversing roller Rb that can rotate in forward and reverse directions and that is an example of the medium transporting means is disposed. Above a bifurcation position between the paper discharge path SH3 and the upper transport path SH4, a reversing path SH6 which is an example of the medium transport path branches off from the upper transport path SH4 toward a lower left side.

A gate GT1 which is an example of switching means is disposed across a bifurcation portion between the paper discharge path SH3 and the upper transport path SH4 and a bifurcation portion between the upper transport path SH4 and the reversing path SH6. The gate GT1 guides the recording sheet S from the fixing device F toward the lower paper discharge tray TRh, and is supported to be switchable between a first guide position (second position) at which the recording sheet S is guided from the upper transport path SH4 to the reversing path SH6 and a second guide position (first position) at which the recording sheet S is guided from the fixing device F to the upper transport path SH4.

On the reversing path SH6, a plurality of the transport rollers Ra each of which is an example of the medium transporting means are disposed. A downstream end of the reversing path SH6 joins the paper feed path SH1 upstream of the registration roller Rr.

### Description of Image Forming Operation

In the copier U of Example 1 having the above configuration, in a case where the document Gi is to be copied with the document Gi manually placed on the platen glass PG by a worker, the reading unit U2a moves in the right-left direction from an initial position and the document Gi on the platen glass PG is scanned while being exposed to light. In addition, in a case where the document Gi is to be copied with the document Gi automatically transported via the autofeeder U3, a plurality of the documents Gi accommodated in the document tray TG1 are sequentially transported to a document reading position on the platen glass PG, sequentially pass through the document reading position, and are discharged to the document discharge tray TG2. The documents Gi that sequentially pass through the reading position on the platen glass PG are exposed to light of the reading unit U2a and scanned. Reflected light from the document Gi is received by the reading unit U2a. The reading unit U2a converts the received reflected light from the document Gi into an electrical signal. Note that in a case where both sides of the document Gi are to be read, the document Gi is also read by a reading sensor.

The electrical signal output from the reading unit U2a is input to the image processing unit GS. The image processing unit GS converts electrical signals of R, G, and B color images read by the reading unit U2a into yellow (Y), magenta (M), cyan (C), and black (K) image information for formation of a latent image. The image processing unit GS outputs the converted image information to the writing circuit DL of the printer section U1. In a case where an image is a monochromatic image (so-called monochrome), the image processing unit GS outputs, to the writing circuit DL, image information of black K only.

The writing circuit DL outputs, to the exposure devices LHy to LHk, a control signal corresponding to the image information input thereto. The exposure devices LHy to LHk output writing light beams corresponding to the control signal.

Each of the photoreceptors PRy to PRk is rotationally driven as image formation is started. A charging voltage is applied to the charging rollers CRy to CRk from the power supply circuit E. Therefore, surfaces of the photoreceptors PRy to PRk are charged by the charging rollers CRy to CRk. Electrostatic latent images are formed on the surfaces of the charged photoreceptors PRy to PRk in the writing regions Q1y to Q1k by the exposure devices LHy to LHk. The electrostatic latent images of the photoreceptors PRy to PRk are developed into toner images each of which is an example of a visible image by the developing devices Gy to Gk in the development regions Q2y to Q2k.

The developed toner images are transported to the primary transfer regions Q3y to Q3k that come into contact with the intermediate transfer belt B which is an example of the intermediate transfer body. In the primary transfer regions Q3y to Q3k, a primary transfer voltage having a polarity opposite to the charging polarity of a toner is applied to the primary transfer rollers T1y to T1k from the power supply circuit E. Therefore, the respective toner images on the photoreceptors PRy to PRk are transferred to the intermediate transfer belt B by the primary transfer rollers T1y to T1k. In the case of multi-color toner images, a toner image on a downstream side is transferred to be superimposed on a toner image that is transferred to the intermediate transfer belt B in a primary transfer region on an upstream side.

Residues and adhering substances on the photoreceptors PRy to PRk after primary transfer are cleaned by the photoreceptor cleaners CLy to CLk. The surfaces of the photoreceptors PRy to PRk after cleaning are subjected to static elimination by the static eliminators Jy to Jk. The surfaces of the photoreceptors PRy to PRk after static elimination are re-charged by the charging rollers CRy to CRk.

Monochromatic or multi-color toner images transferred onto the intermediate transfer belt B by the primary transfer rollers T1y to T1k in the primary transfer regions Q3y to Q3k are transported to the secondary transfer region Q4.

The recording sheet S on which an image is to be recorded is taken out by the pick-up rollers Rp of the paper feed trays TR1 to TR4 to be used. In a case where a plurality of the recording sheets S are taken out in an overlapping manner, the recording sheets S taken out by the pick-up roller Rp are separated one by one by the separating roller Rs. The recording sheet S separated by the separating roller Rs is transported to the paper feed path SHI by the transport rollers Ra. The recording sheet S transported to the paper feed path SHI is sent to the registration roller Rr. The recording sheet S loaded on the manual tray TR0 is also sent to the paper feed path SH1 through the manual paper feed path SH0 by the pick-up roller Rp0.

The registration roller Rr transports the recording sheet S to the secondary transfer region Q4 in accordance with a time at which the toner image formed on the intermediate transfer belt B is transported to the secondary transfer region Q4. A secondary transfer voltage having a polarity opposite to the charging polarity of the toner is applied to the secondary transfer roller T2b by the power supply circuit E. Therefore, the toner image on the intermediate transfer belt B is transferred from the intermediate transfer belt B to the recording sheet S.

After secondary transfer, adhering substances and the like adhering to a surface of the intermediate transfer belt B are cleaned by the belt cleaner CLb.

The recording sheet S onto which the toner image is secondarily transferred is heated for fixation in a case where the recording sheet S passes through the fixing region Q5.

In a case where post-processing is to be performed, the recording sheet S on which the image is fixed is transported to the finisher U4 which is an example of the post-processing device installed at the lower paper discharge tray TRh. In a case where the recording sheet S is not to be subjected to the post-processing, the recording sheet S is transported to the upper paper discharge tray TRh2. In a case where the recording sheet S is to be transported to the lower paper discharge tray TRh, the gate GT1 moves to the first guide position. Therefore, the recording sheet S sent out from the fixing device F is transported to the paper discharge path SH3. The recording sheet S transported to the paper discharge path SH3 is transported toward the finisher U4 and the lower paper discharge tray TRh by the paper discharge roller Rh.

The finisher U4 performs a binding process, which is an example of post-processing, with respect to the recording sheet S, and then discharges the recording sheet S to the lower paper discharge tray TRh.

In a case where the recording sheet S is to be discharged to the upper paper discharge tray TRh2, the gate GT1 moves to the second guide position so that the recording sheet S is discharged to the upper paper discharge tray TRh2.

In a case where the recording sheet S is to be subjected to two-sided printing, the gate GT1 moves to the second guide position. Then, in a case where a trailing end of the recording sheet S passes through the gate GT1, the gate GT1 moves to the first guide position and the reversing roller Rb rotates in a reverse direction. Therefore, the recording sheet S is guided by the gate GT1 to be sent to the reversing path SH6. The recording sheet S transported to the reversing path SH6 is sent to the registration roller Rr in a state where front and back sides are reversed.

### Description of Fixing Device

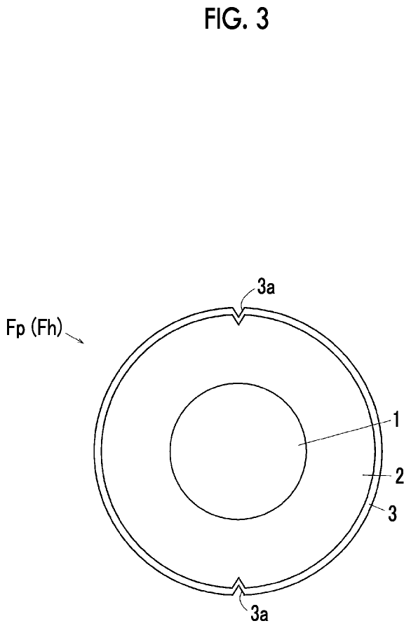

FIG. 3 is a cross-sectional view of a fixing unit of a fixing device of Example 1.

In FIG. 3, each of the heating roller Fh, which is an example of a fixing unit of Example 1 and is an example of a heating unit, and the pressing roller Fp, which is an example of a fixing unit and is an example of a pressing unit, includes a core metal 1 which is an example of a shaft portion and is an example of a core material. An elastic layer 2 which is an example of a base layer is formed on an outer periphery of the core metal 1. A release layer 3 which is an example of a surface layer is stacked on an outer surface of the elastic layer 2. The release layer 3 of Example 1 is made of fluororesin, for example. Note that a toner or fluororesin which is favorable in release properties with respect to the recording sheet S is preferable as the release layer 3, for example. However, the present invention is not limited thereto and any material can be adopted for the release layer 3.

The release layer 3 of Example 1 may be manufactured to be integrally molded with a surface of the elastic layer 2 and the elastic layer 2 may be caused to penetrate the inside of a fluororesin tube so that the release layer 3 is stacked on the outer surface of the elastic layer 2.

As described om JP2001-109295A ([0023] to [0035] and FIG. 3), a crease may be formed at a fluororesin tube in a manufacturing stage and a crease 3a may remain even in a case where the fluororesin tube is stacked on the elastic layer 2. Note that it is also possible to perform a process of flattening the crease 3a as described in JP2001-109295A ([0023] to [0035] and FIG. 3).

In addition, although a case where both of the heating roller Fh and the pressing roller Fp have the same configuration as each other has been described in Example 1, the present invention is not limited thereto. It is also possible to configure any one of the heating roller Fh or the pressing roller Fp by using a fixing belt.

### Description about Control Section of Example 1

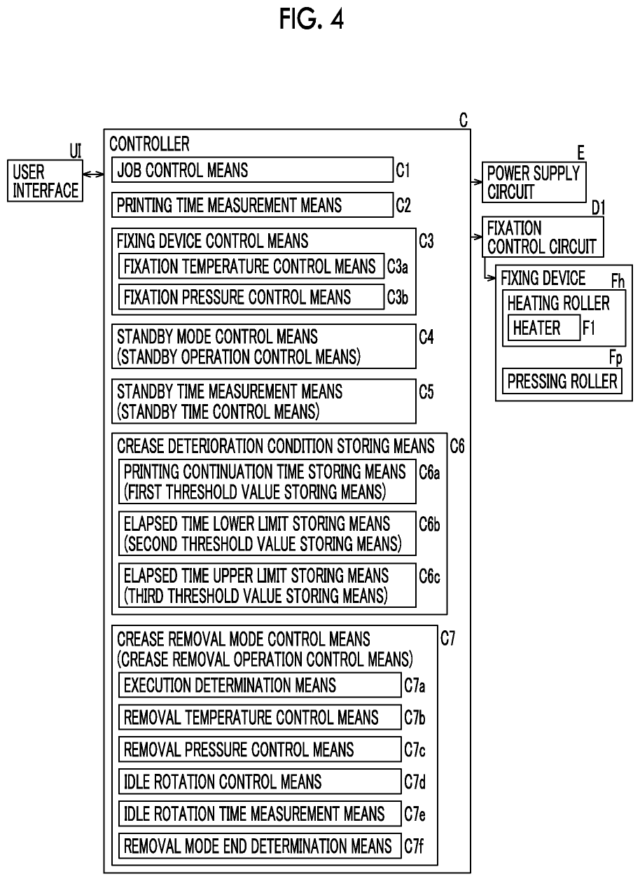

FIG. 4 is a functional block diagram of a control section of Example 1.

In FIG. 4, the control section (a controller) C which is an example of a controlling unit of the copier U includes an input/output interface I/O through which a signal is input and output from and to the outside. In addition, the control section C includes a read-only memory (ROM) in which a program, information, and the like for necessary processing are stored. In addition, the control section C includes a random access memory (RAM) for temporary storage of necessary data. In addition, the control section C includes a central processing unit (CPU) that performs processing corresponding to the program stored in the ROM or the like. Therefore, the control section C of Example 1 is composed of a small information-processing device (a so-called microcomputer). Therefore, the control section C can realize various functions by executing the program stored in the ROM or the like.

A signal from a signal outputting element is input to the control section C of Example 1 and the control section C outputs a signal to a control target element to control the control target element.

### Description about Signal Outputting Element

A signal from the signal outputting element such as a user interface UI and a sensor that is not shown is input to the control section C.

The user interface UI inputs, to the control section C, a content input by a user or an operator. In Example 1, a control signal is input to the control section C in a case where a copying start instruction, which is an example of a printing instruction, is input through the user interface UI, for example.

### Description about Control Target Element

The control section C outputs a signal to the power supply circuit E, a fixation control circuit D1, and other control target elements (not shown).

The power supply circuit E controls supply and the like of power such as a charging bias for the charging rollers CRy to CRk, a development bias for the developing devices Gy to Gk, a primary transfer bias for the primary transfer rollers T1y to T1k, and a secondary transfer bias for the secondary transfer roller T2b.

The fixation control circuit D1 controls supply of power to a heater F1 which is an example of heat generation means and is an example of a heat source. In addition, the fixation control circuit D1 controls rotation of the pressing roller Fp by controlling the driving of a fixation motor M1 which is an example of fixation driving means. Note that the present invention is not limited to a configuration in which the pressing roller Fp is driven and a configuration in which the heating roller Fh is driven or a configuration in which both of the heating roller Fh and the pressing roller Fp are driven may also be adopted.

### Function of Control Section C

The control section C of Example 1 includes functional means C1 to functional means C7 (functional modules and program modules) as follows.

Job control means C1 controls a job that is an image forming operation. The Job control means C1 executes a job by controlling the power supply circuit E or a motor (not shown) in a case where a copying start instruction is input or a case where printing data is input from an external information processing apparatus or the like (that is, in a case where an instruction to start a job is issued).

Printing time measurement means C2 measures a printing time t1 which is an example of an operation time. The printing time measurement means C2 of Example 1 starts measurement of the printing time t1 in a case where a job is started and ends the measurement of the printing time t1 in a case where the job ends.

Fixing device control means C3 includes fixation temperature control means C3a and fixation pressure control means C3b and controls the fixing device F via the fixation control circuit D1.

The fixation temperature control means C3a controls a fixation temperature at the fixing region Q5 by controlling, via the fixation control circuit D1, the heater F1 to be operated or stopped. The fixation temperature control means C3a controls the heater F1 such that the fixation temperature falls within a predetermined range during the job.

The fixation pressure control means C3b controls a fixation pressure which is a contact pressure between the heating roller Fh and the pressing roller Fp. The fixation pressure control means C3b controls the fixing device F such that the fixation pressure is maintained at a predetermined pressure during the job.

Standby mode control means C4 which is an example of standby operation control means controls the operation of the copying machine U at the time of a standby mode. In Example 1, a transition to the standby mode which is an example of a standby operation is made after the job ends and the copying machine U stands by until an instruction to start the next job is issued. In the standby mode of Example 1, the heater F1 of the fixing device F is turned off. In addition, in the standby mode, the pressure in the fixing region Q5 is controlled to become a standby pressure which is lower than the fixation pressure at the time of the job.

Standby time measurement means C5 which is an example of standby time control means measures a standby time t2 which is a time for which the standby mode continues. The standby time measurement means C5 of Example 1 starts measurement of the standby time t2 in a case where the standby mode is started and ends the measurement of the standby time t2 in a case where the standby mode ends.

Crease deterioration condition storing means C6 stores a crease deterioration condition which is a condition under which the crease 3a deteriorates. The crease deterioration condition storing means C6 of Example 1 includes printing continuation time storing means C6a which is an example of first threshold value storing means, elapsed time lower limit storing means C6b which is an example of second threshold value storing means, and elapsed time upper limit storing means C6c which is an example of third threshold value storing means.

The printing continuation time storing means C6a stores a printing continuation time ta which is an example of a first threshold value. In Example 1, the printing continuation time ta is set in advance and is set to ta=30 minutes, for example. The printing continuation time ta is not limited to the exemplary value, and can be set based on the printing time t1 in which the crease 3a deteriorates as found in an experiment or the like.

The elapsed time lower limit storing means C6b stores an elapsed time lower limit tb1 which is an example of a second threshold value. In Example 1, the elapsed time lower limit tb1 is set in advance and is set to tb1=30 minutes, for example. The elapsed time lower limit tb1 is not limited to the exemplary value, and can be set based on the standby time t2 in which deterioration of the crease 3a is started as found in an experiment or the like.

The elapsed time upper limit storing means C6c stores an elapsed time upper limit tb2 which is an example of a third threshold value. In Example 1, the elapsed time upper limit tb2 is set in advance and is set to tb2=5 hours, for example. The elapsed time upper limit tb2 is not limited to the exemplary value, and can be set based on the standby time t2 in which the crease 3a is removed as found in an experiment or the like.

Crease removal mode control means C7 which is an example of crease removal operation control means controls execution of a crease removal mode which is an operation of removing the crease 3a. The crease removal mode control means C7 of example 1 includes execution determination means C7a, removal temperature control means C7b, removal pressure control means C7c, idle rotation control means C7d, idle rotation time measurement means C7e, and removal mode end determination means C7f.

The execution determination means C7a determines whether or not the crease removal mode is to be executed. In a case where a fixation operation is started and the crease deterioration condition is satisfied, the execution determination means C7a of Example 1 determines that the crease removal mode is to be executed. That is, in a case where an instruction to start a job is issued and the crease deterioration condition is satisfied, it is determined that the crease removal mode is to be executed. In Example 1, it is determined that the crease deterioration condition is satisfied in a case where the printing time t1 has reached the printing continuation time ta, the standby time t2 has reached the elapsed time lower limit tb1, and the standby time t2 has not reached the elapsed time upper limit tb2. That is, it is determined that the crease deterioration condition is satisfied in a case where the printing time t1 which is an operation time at a previous fixing operation has reached the printing continuation time ta and the standby time t2 which is a time that has elapsed after from the end of the previous fixing operation falls within a predetermined range (from the elapsed time lower limit tb1 to the elapsed time upper limit tb2).

Note that in Example 1, whether or not the crease removal mode is to be executed is determined by using the printing time t1 and the standby time t2 which are parameters relating to the temperature of the elastic layer 2 or the release layer 3 of the heating roller Fh or the like. However, the present invention is not limited thereto. For example, a configuration in which the temperature of the heating roller Fh or the like is measured by a temperature sensor or the like and the crease removal mode is executed in a case where the temperature of the heating roller Fh or the like falls within a predetermined temperature range may also be adopted. Alternatively, other parameters that change together with the temperature of the heating roller Fh or the like such as a time for which a heater is energized, consumed power, and the cumulative number of rotations of a motor, may also be used.

The removal temperature control means C7b controls a fixation temperature at the time of execution of the crease removal mode. In Example 1, the heater F1 is controlled via the fixation control circuit DI such that a removal temperature which is a fixation temperature at the time of execution of a job is reached in a case where the crease removal mode is started. Note that the removal temperature is not limited to the same temperature as the fixation temperature and may be higher or lower than the fixation temperature depending on the heatproof temperature of each member, a target period of time until crease removal, or the like. Note that, for example, it is preferable the removal temperature is a high temperature since the higher the removal temperature is, the easier the removal of a crease is.

The removal pressure control means C7c controls a fixation pressure at the time of execution of the crease removal mode. In Example 1, the fixing device F is controlled via the fixation control circuit D1 such that a removal pressure lower than a fixation pressure at the time of execution of a job is reached in a case where the crease removal mode is started. In Example 1, the removal pressure is set to the same pressure as a pressure at the time of the standby mode. However, the present invention is not limited thereto and the pressure may be high or low or the fixation pressure may be zero (that is, the heating roller Fh and the pressing roller Fp may be separated from each other). Note that, for example, it is preferable that the fixation pressure is low since the lower the fixation pressure is, the smaller a load and a stress applied to the crease 3a are. However, in a case where the heating roller Fh and the pressing roller Fp are separated from each other, the heating roller Fh cannot be rotated in the case of a configuration in which the pressing roller Fp is driven and the heating roller Fh is driven by the pressing roller Fp as in Example 1. Therefore, in a case where the heating roller Fh and the pressing roller Fp are to be separated from each other, adopting a configuration in which both of the heating roller Fh and the pressing roller Fp are driven is desirable, for example.

The idle rotation control means C7d controls rotation of the heating roller Fh and the pressing roller Fp at the time of execution of the crease removal mode. In Example 1, the heating roller Fh and the pressing roller Fp are caused to rotate via the fixation control circuit DI in a case where the crease removal mode is started. That is, the heating roller Fh and the pressing roller Fp are caused to rotate (caused to perform so-called idle rotation) without a developer fixing operation. For example, a case where the idle rotation is performed is preferable since temperature unevenness of the heating roller Fh is suppressed in comparison with a case where the idle rotation is not performed.

In addition, in the crease removal mode of Example 1, the heating roller Fh or the like is caused to rotate at a lower speed than a rotation speed at the time of execution of a job. In Example 1, the rotation speed is set to be lower than the rotation speed at the time of a job. However, the present invention is not limited thereto and the rotation speed may be a high speed or a low speed. Note that, for example, it is preferable that the rotation speed is low since the lower the rotation speed is, the smaller a load and a stress applied to the crease 3a are.

The idle rotation time measurement means Ce measures an idle rotation time t3 which is an example of a time for which the crease removal mode is executed. The idle rotation time measurement means C7e of Example 1 starts the measurement in a case where the idle rotation is started by the idle rotation control means C7d and ends the measurement in a case where the idle rotation ends.

The removal mode end determination means C7f determines whether or not the crease removal mode is to be ended. The removal mode end determination means C7f of Example 1 determines that the crease removal mode is to be ended in a case where the idle rotation time t3 reaches a predetermined removal end time tc. For example, the removal end time tc can be set to tc=1 minute. Note that the removal end time tc is not limited to the exemplified time and can be changed to any time in accordance with a design, specifications, and the like. In addition, the removal end time tc is not limited to a fixed value. For example, the removal end time tc may be a changeable value as in a case where the shorter the standby time t2 is, the shorter the removal end time tc is or a case where the higher a removal temperature at the time of start of the crease removal mode is, the shorter the removal end time tc is.

### Description of Flowchart

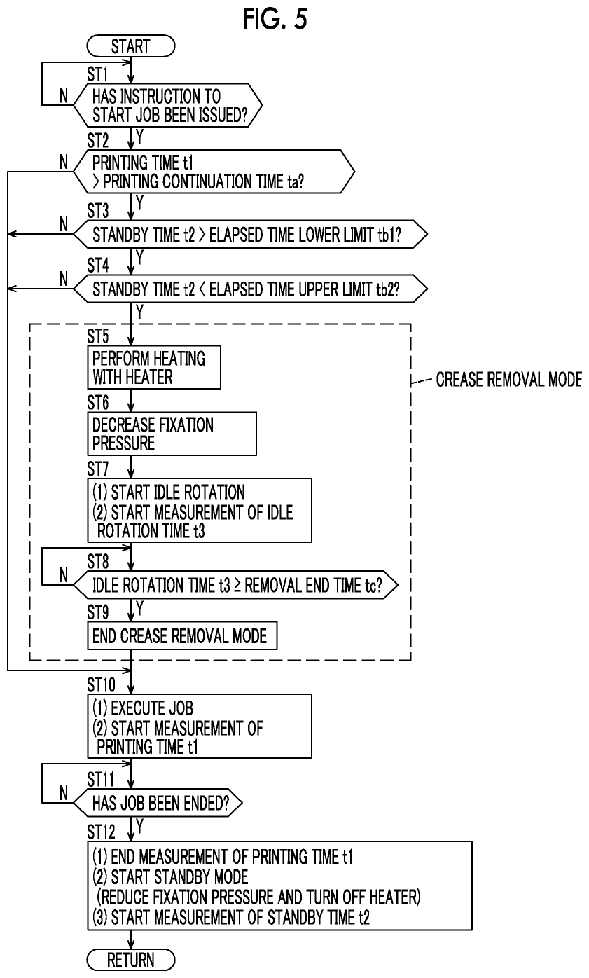

FIG. 5 is a flowchart of a control process for the fixing device of Example 1.

Next, in the following description of a so-called flowchart of control of the copier U of Example 1, a process that needs to be described for description of the invention will be described in detail and description of other processes will be omitted.

A process shown in FIG. 5 is executed in parallel with other processes in the copier U.

The process of FIG. 5 is started in a case where power is supplied to the copier U (that is, the copier U is turned on).

In ST1 of FIG. 5, it is determined whether or not an instruction to start a job has been issued. In a case where the result of the determination is “Yes” (Y), the process proceeds to ST2. In a case where the result of the determination is “No” (N), ST1 is repeated.

In ST2, it is determined whether or not the printing time t1 is larger than the printing continuation time ta. In a case where the result of the determination is “Yes” (Y), the process proceeds to ST3. In a case where the result of the determination is “No” (N), the process proceeds to ST10.

In ST3, it is determined whether or not the standby time t2 is larger than the elapsed time lower limit tb1. In a case where the result of the determination is “Yes” (Y), the process proceeds to ST4. In a case where the result of the determination is “No” (N), the process proceeds to ST10.

In ST4, it is determined whether or not the standby time t2 is smaller than the elapsed time upper limit tb2. In a case where the result of the determination is “Yes” (Y), the process proceeds to ST5. In a case where the result of the determination is “No” (N), the process proceeds to ST10.

In ST5, the crease removal mode is started and the heater F1 is controlled such that the fixation temperature is increased to the removal temperature. Then, the process proceeds to ST6.

In ST6, the fixing device F is controlled such that the fixation pressure is controlled to be the removal pressure. Then, the process proceeds to ST7.

In ST7, the following processes (1) and (2) are executed. Then, the process proceeds to ST8.
(1) Idle rotation is started.
(2) Measurement of the idle rotation time t3 is started.

In ST8, it is determined whether or not the idle rotation time t3 is equal to or larger than the removal end time tc. In a case where the result of the determination is “Yes” (Y), the process proceeds to ST9. In a case where the result of the determination is “No” (N), ST8 is repeated.

In ST9, the crease removal mode is ended. That is, the idle rotation and temperature and pressure control are ended. Then, the process proceeds to ST10.

In ST10, the following processes (1) and (2) are executed. Then, the process proceeds to ST11.
(1) The job is executed.
(2) Measurement of the printing time t1 is started.

In ST11, it is determined whether or not the job has been ended. In a case where the result of the determination is “Yes” (Y), the process proceeds to ST12. In a case where the result of the determination is “No” (N), ST11 is repeated.

In ST12, the following processes (1) to (3) are executed. Then, the process returns to ST1.
(1) Measurement of the printing time t1 is ended.
(2) The standby mode is started. That is, the fixation pressure is reduced and the heater F1 is turned off.
(3) Measurement of the standby time t2 is started.

### Action of Example 1

In the copier U of Example 1 which has the above-described configuration, whether or not the crease removal mode is to be executed is determined in a case where an instruction to start a job is issued via input of a copying start key, input of printing data from a personal computer, or the like. In a case where the crease deterioration condition is satisfied, the crease removal mode is executed. Then, the job is started after the crease removal mode is ended. In a case where the crease deterioration condition is not satisfied, the job is started without execution of the crease removal mode (in a case where the result of determination is “No” (N) in ST2 to ST4).

In JP2001-109295A ([0023] to [0035] and FIG. 3), in a configuration in which a fluororesin tube with a crease is used as a surface layer, a crease flattening process is executed in a stage before factory shipment before use in an image forming apparatus. Therefore, during use in the image forming apparatus, it is not possible to cope with deterioration of the crease even in a case where the crease deteriorates. Here, the coefficients of thermal expansion of the elastic layer 2 and the release layer 3 of the heating roller Fh or the pressing roller Fp are different from each other and the coefficient of thermal expansion of the elastic layer 2 is generally larger than the coefficient of thermal expansion of the release layer 3. Therefore, during a job, the elastic layer 2 is heated to the fixation temperature and thermally expands, so that a tensile force acts on the release layer 3 (so to speak, the release layer 3 is stretched) and the crease 3a is made inconspicuous. After the job is ended, the crease 3a is made conspicuous and deep since thermal contraction of the elastic layer 2 that occurs in the case of a decrease in temperature of the heating roller Fh or the like is larger than thermal contraction of the release layer 3. In a case where the next job is started in a state where the crease 3a is conspicuous, during printing with respect to a several number of sheets immediately after the start of the job fixation is performed with the release layer 3 being not stretched yet. Therefore, there is a problem that a decrease in image quality in which a lateral stripe (a so-called gross line) is formed on an image along the crease 3a occurs due to the influence of the crease 3a.

On the other hand, in Example 1, the crease removal mode is executed in a case where a condition under which the crease 3a deteriorates is satisfied. That is, before a job is started, the heating roller Fh is heated so that the elastic layer 2 thermally expands, the release layer 3 is stretched, and the crease 3a is made inconspicuous. Then, the job is started in a state where the crease 3a is inconspicuous. Therefore, a decrease in image quality caused by a crease may be suppressed in comparison with the related art described in JP2001-109295A ([0023] to [0035] and FIG. 3) in which it is not possible to cope with a crease deteriorating after operation of the image forming apparatus.

Note that, regarding the crease 3a, in a state immediately after the end of a job where the temperature of the heating roller Fh is still high, the degree of thermal contraction is still small and the crease 3a is inconspicuous. Therefore, in a case where the next job is started in such a state, the adverse effect of the crease 3a is unlikely to occur. Therefore, in a case where the standby time t2 has not reached the elapsed time lower limit tb1, it is determined that the degree of thermal contraction is still small, the crease 3a is inconspicuous, and the adverse effect of the crease 3a is small. Accordingly, the crease removal mode is not executed. Therefore, meaningless execution of the crease removal mode is suppressed in comparison with a case where the crease removal mode is executed every time. Therefore, a decrease in productivity (the number of printed sheets per unit time) is suppressed.

In addition, the degree of thermal contraction of the release layer 3 becomes close to the degree of thermal contraction of the elastic layer 2 in a case where a sufficient time elapses after the end of the job. Accordingly, the crease 3a is made inconspicuous as in an initial state. Therefore, in a case where the next job is started in such a state, the adverse effect of the crease 3a is unlikely to occur. Therefore, in a case where the standby time t2 has reached the elapsed time upper limit tb2, it is determined that a sufficient time has elapsed, the crease 3a is inconspicuous, and the adverse effect of the crease 3a is small. Accordingly, the crease removal mode is not executed. Therefore, meaningless execution of the crease removal mode is suppressed in comparison with a case where the crease removal mode is executed every time. Therefore, a decrease in productivity (the number of printed sheets per unit time) is suppressed.

Furthermore, in Example 1, the fixation pressure is reduced in the crease removal mode. Therefore, a load applied to the crease 3a is reduced in comparison with a case where the fixation pressure is high. Accordingly, the lifespan of the fixing device F is extended. Similarly, in Example 1, the rotation speed of the heating roller Fh is reduced in the crease removal mode. Therefore, a load applied to the crease 3a is reduced in comparison with a case where the rotation speed is high. Accordingly, the lifespan of the fixing device F is extended.

### Modification Examples

Hereinabove, the example of the present invention has been described in detail. However, the present invention is not limited to the above example and various modifications can be made within the scope of the gist of the present invention described in the claims. Modification examples (H01) and (H02) of the present invention will be described below.

(H01) In the example, the copier U has been described as an example of the image forming apparatus. However, the present invention is not limited thereto, and the image forming apparatus can also be configured by using, for example, a printer, a fax machine, or a multifunction machine having a plurality of functions thereof or all of the functions thereof. In addition, the present invention is not limited to an electrophotographic image forming apparatus and the present invention can also be applied to any image forming apparatus such as an inkjet type image forming apparatus or a heat transfer printing type image forming apparatus.

(H02) In the example, the copier U having a configuration in which developing agents of four colors are used has been described. However, the present invention is not limited thereto and for example, the present invention can also be applied to a monochromatic image forming apparatus or a multicolor image forming apparatus in which three or less colors or five or more colors are used.

### Supplementary Note

(((1)))

A fixing device comprising:
a fixing unit that fixes an image on a surface of a medium by pressing the image while heating the image, the fixing unit including a base layer and a surface layer that is composed of a tube having a crease and covering the base layer and of which a coefficient of thermal expansion is different from a coefficient of thermal expansion of the base layer; and
a controlling unit that controls the fixing unit, the controlling unit executing a crease removal operation of smoothing out the crease before a start of a fixing operation in a case where the fixing operation is started and a predetermined condition under which the crease deteriorates is satisfied.
   (((2)))

The fixing device according to (((1))),
wherein the fixing unit that includes a heating unit and a pressing unit is provided, the heating unit being heated by a heat source and rotating and the pressing unit being disposed to face the heating unit and including the base layer and the surface layer.
   (((3)))

The fixing device according to (((2))),
wherein a core material, the base layer that is provided on an outer periphery of the core material and that is composed of an elastic body, and the surface layer that is composed of a fluororesin tube having the crease are provided.
   (((4)))

The fixing device according to any one of (((1))) to (3)
wherein the controlling unit that determines that the condition under which the crease deteriorates is satisfied in a case where an operation time at a previous fixing operation reaches a predetermined first threshold value and an elapsed time after an end of the previous fixing operation falls within a predetermined range is provided.
   (((5)))

The fixing device according to any one of (((1) to ((3)
wherein the controlling unit that determines that the condition under which the crease deteriorates is satisfied in a case where a temperature of the fixing unit falls within a predetermined range is provided.
   (((6)))

The fixing device according to any one of (((1)) to
wherein the crease removal operation in which the fixing unit is heated to a predetermined temperature is performed.
   (((7)))

The fixing device according to any one of (((1)) to (6)
wherein the crease removal operation that is executed in a state where a load applied to the crease is lower than a load applied to the crease at a time of the fixing operation is performed.
   (((8)))

The fixing device according to (((7))),
wherein the crease removal operation in which a pressure applied to the fixing unit is made lower than a pressure applied to the fixing unit at the time of the fixing operation so that the load applied to the crease is made low is performed.
   (((9)))

The fixing device according to (((7))),
wherein the crease removal operation in which the fixing unit is rotated at a speed lower than a rotation speed at the time of the fixing operation so that the load applied to the crease is made low is performed.
   (((10)))

An image forming apparatus comprising:
an image holding unit;
a transfer unit that transfers an image held by the image holding unit to a medium; and
the fixing device according to any one of (((1))) to ((9))), the fixing device fixing the image transferred to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing unit that fixes an image on a surface of a medium by pressing the image while heating the image, the fixing unit including a base layer and a surface layer that is composed of a tube having a crease and covering the base layer and of which a coefficient of thermal expansion is different from a coefficient of thermal expansion of the base layer; and
a controlling unit that controls the fixing unit, the controlling unit executing a crease removal operation of smoothing out the crease before a start of a fixing operation in a case where the fixing operation is started and a predetermined condition under which the crease deteriorates is satisfied.

2. The fixing device according to claim 1,
wherein the fixing unit that includes a heating unit and a pressing unit is provided, the heating unit being heated by a heat source and rotating and the pressing unit being disposed to face the heating unit and including the base layer and the surface layer.

3. The fixing device according to claim 2,
wherein a core material, the base layer that is provided on an outer periphery of the core material and that is composed of an elastic body, and the surface layer that is composed of a fluororesin tube having the crease are provided.

4. The fixing device according to claim 1,
wherein the controlling unit that determines that the condition under which the crease deteriorates is satisfied in a case where an operation time at a previous fixing operation reaches a predetermined first threshold value and an elapsed time after an end of the previous fixing operation falls within a predetermined range is provided.

5. The fixing device according to claim 1,
wherein the controlling unit that determines that the condition under which the crease deteriorates is satisfied in a case where a temperature of the fixing unit falls within a predetermined range is provided.

6. The fixing device according to claim 1,
wherein the crease removal operation in which the fixing unit is heated to a predetermined temperature is performed.

7. The fixing device according to claim 1,
wherein the crease removal operation that is executed in a state where a load applied to the crease is lower than a load applied to the crease at a time of the fixing operation is performed.

8. The fixing device according to claim 7,
wherein the crease removal operation in which a pressure applied to the fixing unit is made lower than a pressure applied to the fixing unit at the time of the fixing operation so that the load applied to the crease is made low is performed.

9. The fixing device according to claim 7,
wherein the crease removal operation in which the fixing unit is rotated at a speed lower than a rotation speed at the time of the fixing operation so that the load applied to the crease is made low is performed.

10. An image forming apparatus comprising:
an image holding unit;
a transfer unit that transfers an image held by the image holding unit to a medium; and
the fixing device according to claim 1, the fixing device fixing the image transferred to the medium.

11. An image forming apparatus comprising:
an image holding unit;
a transfer unit that transfers an image held by the image holding unit to a medium; and
the fixing device according to claim 2, the fixing device fixing the image transferred to the medium.

12. An image forming apparatus comprising:
an image holding unit;
a transfer unit that transfers an image held by the image holding unit to a medium; and
the fixing device according to claim 3, the fixing device fixing the image transferred to the medium.

13. An image forming apparatus comprising:
an image holding unit;
a transfer unit that transfers an image held by the image holding unit to a medium; and
the fixing device according to claim 4, the fixing device fixing the image transferred to the medium.

14. An image forming apparatus comprising:
an image holding unit;
a transfer unit that transfers an image held by the image holding unit to a medium; and
the fixing device according to claim 5, the fixing device fixing the image transferred to the medium.

15. An image forming apparatus comprising:
an image holding unit;
a transfer unit that transfers an image held by the image holding unit to a medium; and
the fixing device according to claim 6, the fixing device fixing the image transferred to the medium.

16. An image forming apparatus comprising:
an image holding unit;
a transfer unit that transfers an image held by the image holding unit to a medium; and
the fixing device according to claim 7, the fixing device fixing the image transferred to the medium.

17. An image forming apparatus comprising:
an image holding unit;
a transfer unit that transfers an image held by the image holding unit to a medium; and
the fixing device according to claim 8, the fixing device fixing the image transferred to the medium.

18. An image forming apparatus comprising:
an image holding unit;
a transfer unit that transfers an image held by the image holding unit to a medium; and
the fixing device according to claim 9, the fixing device fixing the image transferred to the medium.

19. A fixing device comprising:
fixing means for fixing an image on a surface of a medium by pressing the image while heating the image, the fixing means including a base layer and a surface layer that is composed of a tube having a crease and covering the base layer and of which a coefficient of thermal expansion is different from a coefficient of thermal expansion of the base layer; and
controlling means for controlling the fixing means, the controlling means executing a crease removal operation of smoothing out the crease before a start of a fixing operation in a case where the fixing operation is started and a predetermined condition under which the crease deteriorates is satisfied.
